(19) United States
(12) Patent Application Publication
(10) Pub. No.: US 2009/0049543 A1
(43) Pub. Date: Feb. 19, 2009

(54) METHOD FOR BOOTING AND PROTECTING DATA IN HARD DISK OF COMPUTER SYSTEM AND MODULE FOR PROTECTING DATA THEREOF

(75) Inventor: Yi-Teng Yu, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/179,572

(22) Filed: Jul. 24, 2008

(30) Foreign Application Priority Data
Aug. 13, 2007 (TW) 96129841

(51) Int. Cl. H04L 9/32; G06F 15/177

(52) U.S. Cl. 726/18; 713/2

(57) ABSTRACT

A method for protecting data in a hard disk includes the steps of creating a password database in a basic input output system (BIOS) of a computer system and providing a first password column in the password database for a user to set a first password string. When the computer system is booted, a request of inputting a password is sent to the user to continue the booting program of the computer system. When the received password is the first password string, the data in the master boot record of the hard disk is backed up to a storage area, and the data in the master boot record is erased.

### CROSS-REFERENCE TO RELATED APPLICATION

This application claims the priority benefit of Taiwan application serial no. 96129841, filed on Aug. 13, 2007. The entirety of the above-mentioned patent application is hereby incorporated by reference herein and made a part of specification.

### BACKGROUND OF THE INVENTION

1. Field of the Invention

The invention relates to a technology for protecting data and, more particularly, to a method for booting and protecting data in a hard disk of a computer system and a module for protecting data thereof.

2. Description of the Related Art

FIG. 1 is a flow chart showing a conventional method for booting a computer system having a password protection function. In FIG. 1, as shown in the step S102, the conventional method for booting the computer system is executing a power on self test (POST) when the power of the computer system is on. If a user sets a booting password in the setting image of the BIOS, the user is requested to input a password string, as shown in the step S104, when the computer system is booted. The common method is displaying a password input interface on the screen of the computer system.

When the user inputs the password string, the step S106 is executed. That is, whether the password string inputted by the user is the same with a predetermined password string is checked. If the password string inputted by the user does not correspond with the predetermined password string (“no” in the step S106), the step S108 is executed. That is, whether the number of times of wrong input reaches a predetermined number of times such as three is determined. If the number of times of wrong input does not reach three times (“no” in the step S108), the step S104 and so on are repeatedly executed. If the user inputs wrong passwords for three times (“yes” in the step S108), the step S110 is executed. That is, an input error message is sent to the user. When the step S106 is executed, whether the password string inputted by the user corresponds with the predetermined password string (“yes” in the step S106) is checked, and then the step S112 is executed. That is, the computer system is enabled to be normally booted and operated.

Although the conventional booting method utilizes a password to protect data stored in the computer system, it is not safe. Under some conditions, for example, when a hard disk is disassembled and installed to another computer system, the data stored in the hard disk can still be effectively accessed.

### BRIEF SUMMARY OF THE INVENTION

The invention provides a method and a module for protecting data, and the method and module can effectively protect the data from being accessed by an unauthorized user.

The invention further provides a booting method for a computer device, and the booting method can effectively protect data stored in the computer device.

The invention provides a method for protecting data in a hard disk, and the method can be applied to a computer system. The invention includes the steps of creating a password database in the basic input output system (BIOS) of the computer system and providing a first password column in the password database for a user to set a first password string. When the computer system is booted, a request of inputting a password is sent to a user to continue the booting program of the computer system. When a received inputted password string is the first password string, the data in the master boot record of the hard disk is backed up to a storage area, and the data in the master boot record is erased.

The invention provides a booting method for a computer system, and the booting method includes the step of providing a password input interface for a user to input a password. When an inputted password string is received from the password input interface, the inputted password string is compared with password strings stored in a password database of the computer system. If the inputted password string corresponds with a first password string in the password database, a piece of predetermined data in a main storage device of the computer system is backed up to a storage area. The predetermined data which is backed up is erased from the main storage device in the invention.

The invention further provides a module for protecting data, and the module can protect data in a main storage device of a computer system. The module for protecting data provided by the invention includes a password database, an input interface unit, a comparison unit and a read-write unit. The password database stores at least a first password string. The input interface unit provides a password input interface for a user to input an input password string when the computer system is booted. When the user inputs a password string from the password input interface, the comparison unit can compare the inputted password string with the data in the password database and then output a comparison result. When the inputted password string corresponds with the first password string, the read-write unit backs up a piece of predetermined data in the main storage device to a storage area and erases the predetermined data from the main storage device.

In the embodiment of the invention, the password database further stores a second password string and a third password string.

When the comparison unit finds that the inputted password string corresponds with the second password string, it calls the main program of the BIOS of the computer system to enable the computer system to be normally booted and operated.

When the comparison unit finds that the inputted password string corresponds with the third password string, it calls the read-write unit to restore the backup data of the predetermined data in the storage area to the main storage.

Since in the invention, data in the master boot record of a hard disk can be backed up and erased when a user inputs a predetermined password string, only after a user inputs another predetermined password string, the data in the master boot record can be restored. Therefore, when a user sets a protection function, even though an unauthorized user disassembles the hard disk and installs the hard disk to another computer system, he cannot access the data in the hard disk. The invention can effectively protect the data stored in the hard disk.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is a flow chart showing a conventional booting method for a computer system having a password protection function.

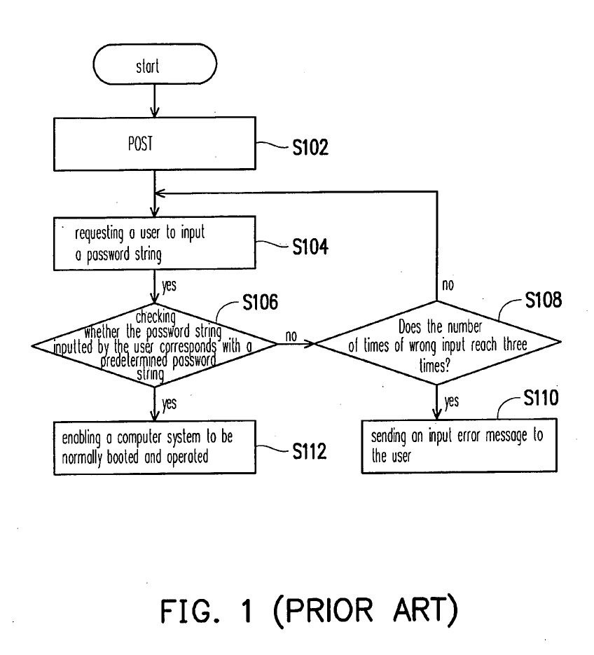

FIG. 2 is a block diagram showing the system configuration of a computer system.

FIG. 3 is a block diagram showing the structure of a basic input output system according to a preferred embodiment of the invention.

FIG. 4 is a structural diagram showing a password database according to a preferred embodiment of the invention.

FIG. 5 is a flow chart showing a method for protecting data according to a preferred embodiment of the invention.

### DETAILED DESCRIPTION OF THE EMBODIMENTS

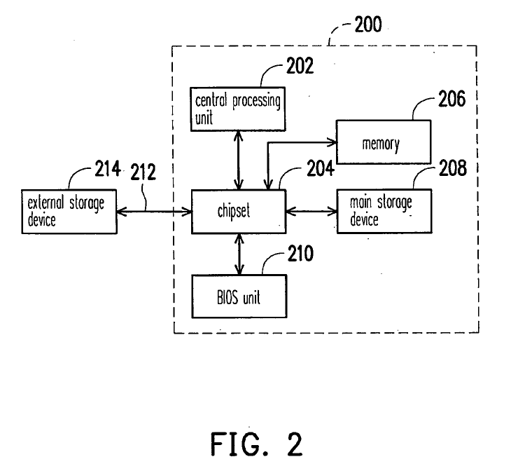

FIG. 2 is a block diagram showing the system configuration of a computer system. As shown in FIG. 2, a computer system 200 may include a central processing unit (CPU) 202, a chip set 204, a main storage device 208 and a basic input output system (BIOS) unit 210. The CPU 202 may be coupled to the chip set 204. Generally speaking, the chip set 204 may include a north bridge chip, a south bridge chip and so on. In this way, the CPU 202 is coupled to a memory 206, the main storage device 208 and the BIOS unit 210 via the chip set 204.

In the embodiment, the memory 206 may be a dynamic random access memory (DRAM), a static random access memory (SRAM) or a double data random access memory (DDRAM). The main storage device 208 is, for example, a hard disk, and the BIOS unit may be a flash memory or a read only memory.

The computer system 200 can also be connected to an external storage device 214 via a connection interface 212 besides having the interior main storage device 208. In some embodiments, the connection interface 212 may be a universal serial bus interface, and the external storage device 214 may be a portable flash memory having a universal serial bus connection interface.

When the computer system 200 is booted, a power on self test (POST) program is executed, and program codes in the BIOS unit 210 are loaded into the memory 206 to be executed. In some embodiments, the BIOS unit 210 can request a user to input a password after the computer system 200 loads the program codes of the BIOS according to the setting of a user, and then the computer system 200 can be normally booted and operated.

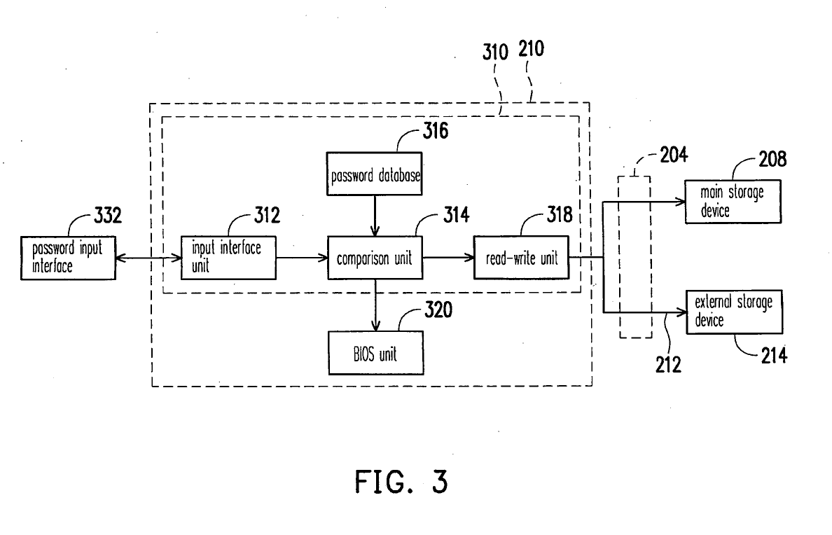

FIG. 3 is a block diagram showing the structure of a BIOS according to a preferred embodiment of the invention. As shown in FIG. 3, the BIOS unit 210 may include a module for protecting data 310 and a BIOS main program 320. In some embodiments, the module for protecting data 310 may be programmed by program codes, and it is coupled to the BIOS main program 320 and may be coupled to the main storage device 208 and the external storage device 214 via, for example, the chip set 204.

The module for protecting data 310 provided in the embodiment includes an input interface unit 312, a comparison unit 314, a password database 316 and a read-write unit 318. The input interface unit 312 is coupled to the comparison unit 314, and the comparison unit 314 is coupled to the password database 316 and the read-write unit 318. The read-write unit 318 can also be coupled to the main storage device 208 and the external storage device 214.

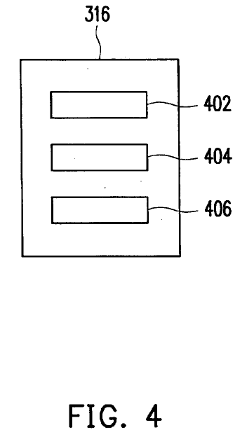

In the embodiment, as shown in FIG. 4, the password database 316 provides a plurality of password columns. The password database 316 in FIG. 4 provides a plurality of password columns such as 402, 404 and 406. In this way, a user can set different password strings in the password columns 402, 404 and 406.

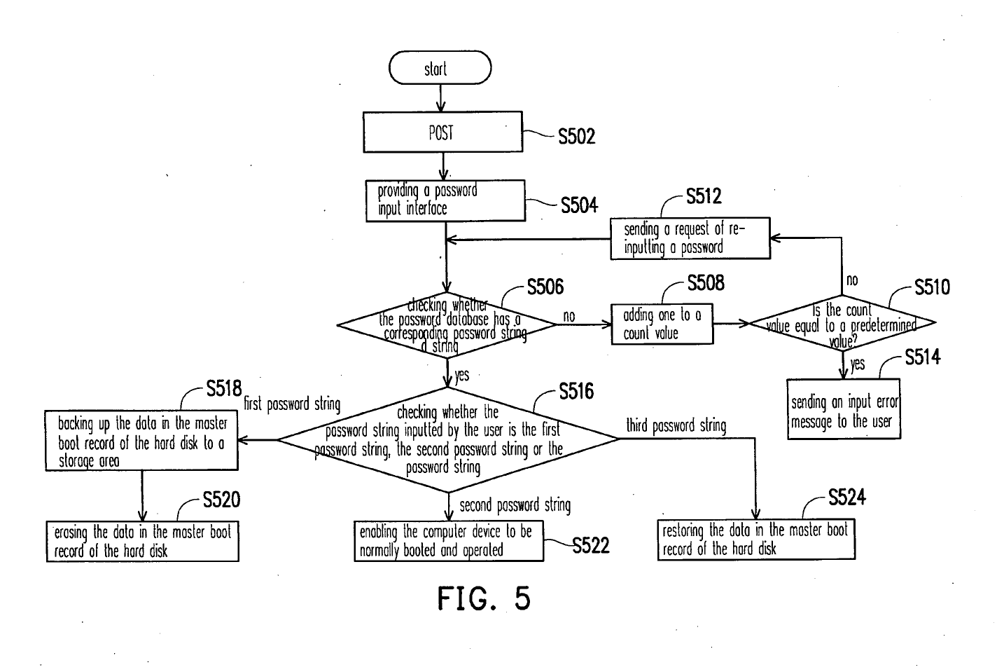

FIG. 5 is a flow chart showing a method for protecting data according to a preferred embodiment of the invention. As shown in FIG. 3 and FIG. 5, when a computer system is booted, as shown in the step S502, a POST program is executed. In the embodiment, the input interface unit 321 in the BIOS unit 210 can provide a password input interface 332 on the booting image of the computer system to allow a user to input a password string via the password input interface 332, as shown in the step S504.

Afterward, when the password string inputted by the user is received, the inputted password string is transferred to the comparison unit 314, and then the comparison unit 314 executes the step S506. That is, whether the password database 316 has a corresponding password string is checked.

When the comparison unit 314 finds that no password string in the password database 316 corresponds with the inputted password string (“no” in the step S506), a count value is added by one. The initial value of the count value is zero. As shown in the step S510, the module for protecting data 310 can also check whether the count value is equal to a predetermined value. In the embodiment, the predetermined value may be three. If the count value is not equal to the predetermined value (“no” in the step S508), the module for protecting data 310 can send a request of re-inputting a password to the user (the step S512). If the count value is equal to the predetermined value, as shown in the step S514, the module for protecting data 310 sends an input error message to the user. The implementing method in the step S514 may be, for example, showing a prompt message on the screen of the computer system or utilizing a loudspeaker to send an audio message.

In the step S506, if a corresponding password string is found in the password database 316 (“yes” in the step S506), as shown in the step S516, the comparison unit 314 can determine what kind of password string the inputted password string corresponds with.

If the comparison unit 314 finds that the inputted password string corresponds with a predetermined first password string (such as the password string in one of the password columns 402, 404 and 406 in FIG. 4), it calls the read-write unit 318. At this moment, the read-write unit 318 can execute the step S518. That is, a predetermined data in the main storage device 208 is backed up to a storage area. In the embodiment, the main storage device 208 may be a hard disk, and therefore, the predetermined data which is backed up by the read-write unit 318 may be the data in the master boot record of the hard disk. The storage area may be the storage space in the external storage device 214.

The read-write unit 318 not only can back up the data in the master boot record of the hard disk 208 but also can erase the data in the master boot record, as shown in the step S520, after backing up the data in the master boot record. Since the data in the master boot record of the hard disk includes the start address and the end address of each sector, if the data in the master boot record of a hard disk is damaged, the data in the hard disk cannot be accessed. Therefore, via the method for protecting data provided by the embodiment, a user can remove the external storage device 214 and carry about the external storage device 214, and an unauthorized user is precluded from accessing the protected data in the hard disk.

Returning to the step S516, if the comparison unit 314 finds that the inputted password string corresponds with a predetermined second password string in the password database 316, it calls the BIOS main program 320 to enable the computer system to be normally booted and operated (the step S522).

In another embodiments, if a user does the steps S518 and S520 on the computer system, when he wants to make the computer system normally booted, he can make the external storage device 214 connected to the computer system first and then input a third password string at the password input interface 332. When the comparison unit 314 finds that the inputted password string corresponds with a predetermined third password string in the password database 316, it can call the read-write unit 318 to execute the step S524 which is restoring the data in the master boot record of the hard disk. The read-write 318 can restore the backup data in the external storage device 214 to the master boot record of the main storage device 208. In this way, the computer system can be normally booted, and the data in the main storage device can also be normally accessed.

To sum up, since in the invention, data in the master boot record of a hard disk can be backed up and erased after a user inputs a predetermined password string, even though an unauthorized user disassembles the hard disk and installs the hard disk to another computer system, he cannot access the data in the hard disk. In this way, the invention can effectively protect the data in the hard disk from being unlawfully accessed.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for protecting data in a hard disk, which is applied to a computer system, the method comprising the steps of:
creating a password database in the basic input output system (BIOS) of the computer system;
providing a first password column in the password database for a user to set a first password string;
sending a request of inputting a password when the computer system is booted; and
backing up data in the master boot record of the hard disk to a storage area and erasing the data in the master boot record when an inputted password string corresponds with the first password string.

2. The method according to claim 1, further comprising the steps of:
providing a second password column in the password database for the user to set a second password string; and
enabling the computer system to be normally booted and operated when the computer is booted and receives the second password string.

3. The method according to claim 1, further comprising the steps of:
providing a third password column in the password database for the user to set a third password string; and
restoring the backup data stored in the storage area to the master boot record of the hard disk when the computer is booted and receives the third password string.

4. The method according to claim 1, wherein the storage area is a portable flash memory externally connected to the computer system.

5. A booting method for a computer system, the booting method comprising the steps of:
providing a password input interface;
when an inputted password string is received from the password input interface, comparing the inputted password string with password strings stored in a password database of the computer system;
when the inputted password string corresponds with a first password string in the password database, backing up a piece of predetermined data in a main storage device of the computer system to a storage area; and
erasing the predetermined data from the main storage device.

6. The booting method according to claim 5 further comprising the step of enabling the computer system to be normally booted and operated when the inputted password string corresponds with a second password string in the password database.

7. The booting method according to claim 5 further comprising the step of restoring the backup data stored in the storage area to the main storage device when the inputted password string corresponds with a third password string in the password database.

8. The booting method according to claim 5, wherein the main storage device is a hard disk.

9. The booting method according to claim 8, wherein the predetermined data is data in the master boot record of the hard disk.

10. The booting method according to claim 5, wherein the storage area is a portable flash memory externally connected to the computer system.

11. The booting method according to claim 5, wherein when no data in the password database corresponds with the inputted password string, the booting method comprises the steps of:
adding one to a count value whose initial value is zero;
determining whether the count value is equal to a predetermined value;
sending a request of re-inputting a password and re-executing the step of comparing the inputted password when the count value is not equal to the predetermined value; and
sending an input error message to the user when the count value is equal to the predetermined value.

12. The booting method according to claim 5, wherein the predetermined value is three.

13. The booting method according to claim 5 further comprising the step of executing a power on self test program.

14. A module for protecting data, which is suitable to protect data in a main storage device of a computer system, the module comprising:
a password database storing at least a first password string;
an input interface unit for providing a password input interface for a user to input an inputted password string when the computer system is booted;
a comparison unit which is coupled to the password database and the input interface unit and is used for comparing the inputted password string with the data in the password database and outputting a comparison result; and
a read-write unit which is coupled to the comparison unit and is used for backing up a piece of predetermined data in the main storage device to a storage area and erasing the predetermined data from the main storage device when the inputted password string corresponds with the first password string.

15. The module for protecting data according to claim 14, wherein the password database further comprises a second password string and a third password string.

16. The module for protecting data according to claim 15, wherein when the comparison unit finds that the inputted password string corresponds with the second password string, it calls the main program of the basic input output system of the computer system to enable the computer system to be normally booted and operated.

17. The module for protecting data according to claim 15, wherein when the comparison unit finds that the inputted password string corresponds with the third password string, it calls the read-write unit to restore the backup data of the predetermined data in the storage area to the main storage.

18. The module for protecting data according to claim 17, wherein the predetermined data is data in the master boot record of a hard disk.
